(19) United States
(12) Patent Application Publication
(10) Pub. No.: US 2019/0130337 A1
(43) Pub. Date: May 2, 2019

(54) DISTURBANCE EVENT DETECTION IN A SHARED ENVIRONMENT

(71) Applicant: Intel Corporation, Santa Clara, CA (US)

(72) Inventors: Dawn Nafus, Hillsboro, OR (US); Daria A. Loi, Portland, OR (US)

(73) Assignee: Intel Corporation, Santa Clara, CA (US)

(21) Appl. No.: 16/231,178

(22) Filed: Dec. 21, 2018

(51) Int. Cl. G06Q 10/06; G06F 9/54; G06N 20/00; H04L 29/08

(52) U.S. Cl. CPC G06Q 10/06398; H04L 67/12; G06N 20/00; G06F 9/542

(57) ABSTRACT

Technology for detecting a disturbance event in a shared environment is described. Sensor data can be received from one or more sensors installed in the shared environment. the disturbance event that occurs in the shared environment can be identified based on the sensor data received from the one or more sensors. The disturbance event can be determined as being unacceptable. An unacceptable event notification can be sent to one or more users in the shared environment.

### BACKGROUND

Open-plan office designs offer attractive financial benefits to an employer by maximizing use of a large open space with a floor plan that minimizes or eliminates the use of small, enclosed rooms such as private offices. Open-plan office designs can also be effective in improving collaboration and teamwork which often increases a group's collective intelligence and enhance overall work product.

However, open-plan office designs can suffer from a number of drawbacks. For example, open-plan office designs can be associated with a reduction in face-to-face interactions, as employees turn to digital communication, such as sending electronic messages for private or sensitive communications. Open-plan office designs can also suffer from increased levels of employee distraction due to activity (e.g. audible or visible activity) in the vicinity that may rise to the level of demanding an employee's attention or awareness. As a result, open-plan office designs can potentially increase stress among employees, conflict between employees, and lower personally efficiency.

### BRIEF DESCRIPTION OF THE DRAWINGS

Features and advantages of technology embodiments will be apparent from the detailed description which follows, taken in conjunction with the accompanying drawings, which together illustrate, by way of example, various technology features; and, wherein:

FIG. 1 illustrates a system for detecting disturbance events in a shared environment in accordance with an example embodiment;

FIG. 2 illustrates a system for detecting disturbance events in a shared environment in accordance with an example embodiment;

FIG. 3 illustrates a layout of a shared environment in accordance with an example embodiment;

FIG. 4 illustrates a technique for providing notifications to users regarding disturbance events in accordance with an example embodiment;

FIG. 5 illustrates environment devices and wearable devices for capturing sensor data and computing devices for processing the sensor data in accordance with an example embodiment;

FIG. 6 is a flowchart illustrating operations for detecting a disturbance event in a shared environment in accordance with an example embodiment; and

FIG. 7 illustrates a computing system that includes a data storage device in accordance with an example embodiment.

Reference will now be made to the exemplary embodiments illustrated, and specific language will be used herein to describe the same. It will nevertheless be understood that no limitation on technology scope is thereby intended.

### DESCRIPTION OF EMBODIMENTS

Before the disclosed technology embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various invention embodiments. One skilled in the relevant art will recognize, however, that such detailed embodiments do not limit the overall technological concepts articulated herein, but are merely representative thereof.

As used in this written description, the singular forms “a,” “an” and “the” include express support for plural referents unless the context clearly dictates otherwise. Thus, for example, reference to “a sensor” includes a plurality of such sensors.

Reference throughout this specification to “an example” means that a particular feature, structure, or characteristic described in connection with the example is included in at least one embodiment of the present invention. Thus, appearances of the phrases “in an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology can be referred to herein along with alternatives for the various components thereof. It is understood that such embodiments, examples, and alternatives are not to be construed as defacto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” “maximized,” “minimized,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a sensor with “increased” sensitivity can refer to a sensor in a sensor array which has a lower level or threshold of detection than one or more other sensors in the array. A number of factors can cause such increased sensitivity, including materials, configurations, architecture, connections, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

An initial overview of technology embodiments is provided below and then specific technology embodiments are described in further detail later. This initial summary is intended to aid readers in understanding the technology more quickly, but is not intended to identify key or essential technological features nor is it intended to limit the scope of the claimed subject matter. Unless defined otherwise, all technical and scientific terms used herein have the same meaning as commonly understood by one of ordinary skill in the art to which this disclosure belongs.

Contemporary office design is increasingly focused on open space office layouts, to maximize real estate usage and light availability, to foster collaboration and to make a statement about a company's culture. These environments can have a number of positive qualities, but can also suffer from a series of pitfalls, such as lack of sound privacy and increased ambient noise, which can reduce productivity.

In one example, the privacy-communication trade-off in open-plan office settings (e.g., the lack of sound privacy but increased ease of communication) can have a negative impact on employee efficiency, morale and workspace satisfaction. For example, an increased number of people working in open-plan office settings can be dissatisfied with their working environment and can have trouble concentrating due to the increased ambient noise in open-plan office settings. Further, an increased number of people believe that working privately is important, and that a reduced number of people are able to be productive in open-plan office settings and may leave the office in order to get work done. In addition, due to the increased number of distractions in open-plan office settings, workers can waste an increased amount of time per day, thereby reducing productivity.

In one example, these open-plan office settings, in which conversations are generally within earshot, can be difficult to inhabit as workers can inadvertently create disturbance events (e.g., auditory events) that impact other employees' ability to work or quality of life. While eating noises, corridor chatter, talking on the phone and similar behaviors can all be appropriate (and expected) disturbance events in a shared environment, it can be difficult for individuals to calibrate when they are generating noise or engaging in other behaviors at disruptive levels. While loudness can be one issue, frequency, the nature of the disturbance, and the topics being inadvertently overheard can be issues that affect workers in open-plan office settings as well.

In one example, while other people's disturbances (e.g., noises) can be easily identified when they are problematic to the hearer, it can be harder to know when one's own activities constitute a problem for others in the open-plan office setting. These issues can be difficult to solve by social convention, as a disturbance-maker might not be aware that they are causing a disturbance, or might not be able to ask whether their disturbances are bothering others without stigma or other social penalties. Even if asked, workers that experience the disturbance can be likely to feel obliged to say that the disturbance-maker is not bothersome even when they are. In addition, the problem can sometimes be intermittent, and therefore too infrequent to warrant breaching social norms by complaining about the disturbance-maker but frequent enough to induce stress or reduce productivity.

Therefore, systems are herein described that can defuse a socially difficult situation by de-personalizing how disturbance-makers become aware that their disturbances (e.g., noises) are a problem for others in the open-plan office setting. The systems can give potential disturbance-makers an opportunity to ask about the effects of their behavior on others, but also contain safeguards against shaming or bullying by workers that experience the disturbance. In one example, the system can be an opt-in system that can track disturbance events (e.g., auditory events) while leveraging effective computing to assess annoyance levels, and act as a mediator between disturbance-makers and disturbance-experiencers by pooling and anonymizing noise and annoyance events. Upon installation of the system, participants can be monitored using various modalities of emotion sensing (e.g., sensing technologies to establish an individual's emotional states), such as cameras, sound detectors, physiological sensing, or through other contextual data).

In one example, previous solutions involved devices that focused on sound-blocking and sound-masking acoustic disturbances. For example, workspace designers and firms have used various techniques to seal, absorb or mask unwanted disturbances (e.g., sounds) by modifying physical attributes of the environment. Other previous solutions have involved systems for detecting and displaying interruptions, which involved visualizing conversations between individuals. In that previous system, table microphones would capture individual audio streams from the individuals, and a visualization of the streams would be projected onto a tabletop surface in real time. In that previous system, audio detection was used for visualizing individual audio streams, such that the individuals could simultaneously have a visual depiction of the streams, including their own audio stream.

In contrast, the present systems focus on reducing disturbances in the environment by enabling a disturbance-maker to become aware of his/her behavior, thereby allowing prevention and reduction of disturbances in the environment. Further, the present systems use audio detection (as well as video detection, motion detection, etc.) to make individuals aware of the impact that their own output (e.g., auditory output) has on others in the environment. In the present systems, the individual can be a recipient of the output, and individual data may not be shared among participating individuals.

In one example, when users wish to understand whether their own behaviors are impacting others, a system can provide two distinct options, both determined by the nature of the disturbance or the specific activity. In the first option, the user can direct the system to log a current event—in this case the system can be triggered to assemble data from surrounding individuals from N previous minutes, wherein N is an integer. A system administrator or user can adjust the value of N depending on the environment. When an annoyance level has reached a certain threshold for a majority of users, the system can deliver feedback accordingly. In the second option, the user can focus on a distinct type of recurring disturbance of concern (e.g., eating noise, “phone voice”). In this case, a system can take and log a sample of the disturbance event of concern when it occurs, and then the system can deliver feedback accordingly if the annoyance level reaches a certain threshold for the majority of users.

In one example, thresholds for what constitutes a majority of users or an elevated annoyance can be adjusted by systems administrators. Further, users can be asked to be notified when an ambient annoyance level is elevated, which can be thresholded for intensity and prevalence at a level slightly above the previously described occasions when there is a specific disturbance of concern, which can reduce the chance of false positives creating in people a sense that they have annoyed others. To reduce the risk that this aspect of the system would be used to query annoyance levels for reasons other than disturbance, ambient disturbance monitors can be used to record general levels (e.g., general decibel levels), and if those monitors suggest that the disturbance level is relatively low, but collective annoyance levels are relatively high, the system may not trigger a notification.

In one configuration, the systems can enable participating individuals to declare particular requests for quiet time. For this feature to work effectively and not be abused, participants can be coached by the system to use this feature in circumstances where there is a specific urgency (e.g., preparing for a presentation that is to be given in the next hour) versus general preferences for quiet time. Additionally, participants can be allowed to declare a request for quiet time in limited intervals (e.g., the next half hour). If a majority of participants in a shared space declare a request for quiet time for the same time period (e.g., a time period of 30 minutes), the system can automatically notify all participants that quiet time would be particularly appreciated for the given time slot.

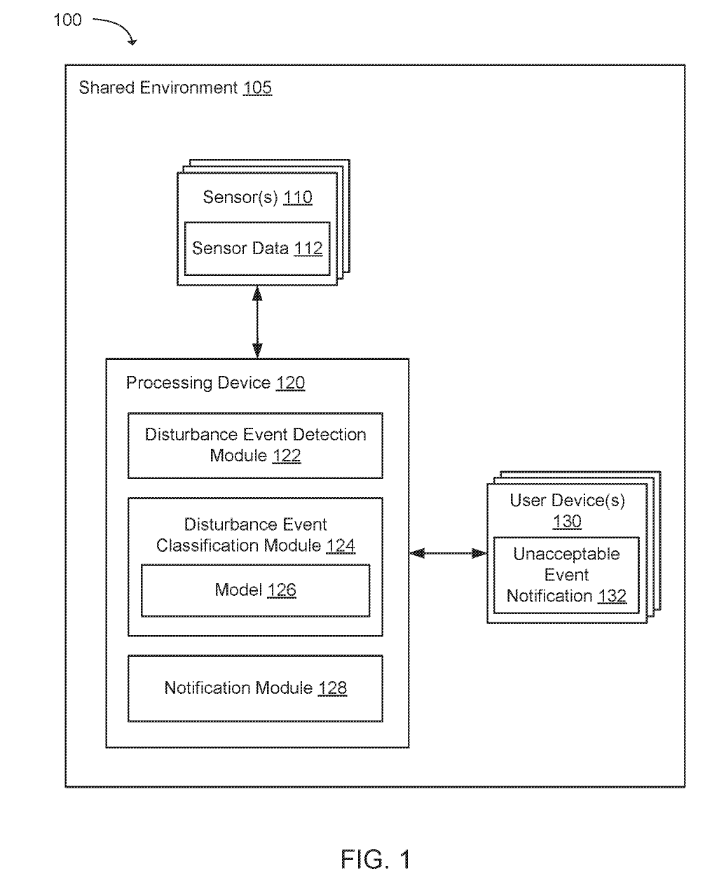

FIG. 1 illustrates an exemplary system 100 for detecting disturbance events in a shared environment 105. The system 100 can monitor disturbance events that occur in the shared environment 105 on a real-time basis. For example, the system 100 can be installed in the shared environment 105, such as a shared work environment, and the system 100 can monitor and notify about disturbance events that are detected in the shared environment 105.

In one example, the system 100 can include a processing device 120, a plurality of sensor(s) 110 and user device(s) 130. The processing device 120, the sensors 110 and the user devices 130 can communicate with each other using a local network that is included in the shared environment 105. The shared environment 105 can include, but is not limited to, an open-plan office setting, a classroom, a restaurant, a park, an outdoor plaza, an arena, etc. In one example, the local network can be a wireless local area network (WLAN). The processing device 120 may include one or more processors and memory configured to process sensor data 112 received from the plurality of sensors 110 and generate notifications regarding disturbance events. The sensors 110 can include, but are not limited to, sound detectors, video cameras, temperature sensors, photo sensors, motion detectors, vibration sensors, etc. The sensor data 112 can include, but is not limited to, audio/video data, temperature data, photo sensor data, motion data, vibration data, etc. In addition, the user devices 130 may include computing devices or mobile devices with a display screen. The user devices 130 may be used by users in the shared environment 105.

In one example, a “disturbance event” as described herein refers to an event that is disruptive to one or more users in the shared environment 105, such as the shared work environment. The disturbance event can affect or disturb one or more senses of the one or more users in the shared environment 105, such as sight, sound, touch, smell or taste, such that the disturbance event causes the one or more users to be impeded or effectively disabled when performing a task in the shared environment 105. The disturbance event can be caused by one or more workers in the shared environment 105. As non-limiting examples, the disturbance event can include a conversation between multiple employees that causes increased noise, a phone call by an employee that causes increased noise, music playback that causes increased noise, food consumption or item dropping that causes increased noise or sudden spikes in noise, a space heater that causes a room to have an increased temperature, bright lights or vibrations from a massage chair that causes sensory overload, an employee that has a foul odor, etc. Thus, the disturbance event can include an auditory disturbance or any other sensory disturbance.

As described herein, the terms “employee”, “worker” and “user” can be used interchangeably to indicate a person in the shared environment 105.

In one configuration, the sensors 110 can be installed in various regions of the shared environment 105. For example, the sensors 110 can be installed in corner regions of the shared environment 105, on desks in the shared environment 105, on a ceiling of the shared environment 105, etc. In addition, the processing device 120 may be centrally located or installed within the shared environment 105.

In one example, the sensors 110 can capture the sensor data 112 in the shared environment 105. The sensors 110 can send the sensor data 112 to the processing device 120. The processing device 120 can receive the sensor data 112 from the sensors 110. For example, the sensors 110 and the processing device 120 can include a transceiver that enables the sending/receiving of the sensor data 112.

In one example, the processing device 120 can include a disturbance event detection module 122 configured to identify when a disturbance event occurs in the shared environment 105 based on the sensor data 112 received from the sensors 110. The processing device 120 can continually receive and process the sensor data 112 in order to detect when a disturbance event occurs in the shared environment 105. For example, the disturbance event detection module 122 can monitor noise levels in the shared environment 105 based on the sensor data 112 (e.g., audio data), and the disturbance event detection module 122 can detect a disturbance event when the noise levels in the shared environment 105 reach a certain threshold. In another example, the disturbance event detection module 122 can monitor noise levels in the shared environment 105 based on the sensor data 112, and the disturbance event detection module 122 can detect a disturbance event when a spike in noise level occurs in the shared environment 105.

In one example, the disturbance event detection module 122 can visually monitor user actions that occur in the shared environment 105 based on the sensor data 112 (e.g., video data), and the disturbance event detection module 122 can detect a disturbance event when certain user actions occur in the shared environment 105 (e.g., dancing or running in the office). In another example, the disturbance event detection module 122 can monitor a brightness level in the shared environment 105 based on the sensor data 112 (e.g., photo sensor data), and the disturbance event detection module 122 can detect a disturbance event when the brightness level reaches a defined threshold in the shared environment 105. In another example, the disturbance event detection module 122 can monitor an odor level in the shared environment 105 based on the sensor data 112 (e.g., odor data), and the disturbance event detection module 122 can detect a disturbance event when the odor level reaches a defined threshold in the shared environment 105. In yet another example, the disturbance event detection module 122 can monitor a temperature level in the shared environment 105 based on the sensor data 112 (e.g., temperature data), and the disturbance event detection module 122 can detect a disturbance event when the temperature level reaches a defined threshold in the shared environment 105. In another example, the disturbance event detection module 122 can monitor a vibration level in the shared environment 105 based on the sensor data 112 (e.g., vibration data), and the disturbance event detection module 122 can detect a disturbance event when the vibration level reaches a defined threshold in the shared environment 105 (e.g., due to a worker's vibrating chair or physical activity such as jumping).

In one example, the disturbance event detection module 122 can determine that no disturbance events have occurred in the shared environment 105 based on the sensor data 112. For example, the sensor data 112 may indicate that no abnormal or sudden noises, sudden changes in temperature or brightness levels, etc. have occurred in the shared environment 105, and in this case, the disturbance event detection module 122 may not determine a disturbance event as having occurred in the shared environment 105.

In one configuration, the processing device 120 may include a disturbance event classification module 124 that determines, using a model 126, whether the disturbance event that occurs in the shared environment 105 is unacceptable or acceptable. For example, certain disturbance events that occur in the shared environment 105 can be classified as acceptable when the disturbance event is transitory, unavoidable, expected for a certain user given the user's unique circumstances, etc. For example, certain noises such as coughs, sneezes, sudden noises when an item is dropped, etc. can generally be considered as brief and unavoidable, and therefore, the disturbance event classification module 124 can determine, using the model 126, that these disturbance events are acceptable in the shared environment 105. Alternatively, certain disturbance events that occur in the shared environment 105 can be classified as unacceptable when the disturbance event is prolonged, avoidable and generally disruptive in the shared environment 105. For example, the disturbance event classification module 124 can determine, using the model 126, that a disturbance event is unacceptable when a noise level or an event duration exceeds a defined threshold. In this example, certain events such as loud conversations or loud music can be classified as unacceptable in the shared environment 105.

In one example, the model 126 used by the disturbance event classification module 124 to classify the disturbance event can include, but is not limited to, a machine learning model, an artificial intelligence (AI) model, a neural network, a support vector machine, a Bayesian network, a genetic algorithm, etc. The model 126 can use predictive analytics, supervised learning, semi-supervised learning, unsupervised learning, reinforcement learning, etc.

In one configuration, the model 126 can be generated and trained using training data. The training data can include data on acceptable disturbance events and data on unacceptable disturbance events. The model 126 can be trained to distinguish between disturbance events that are unacceptable versus disturbance events that are acceptable. In addition, the model 126 can continue to receive additional training data over time, in order to recognize new types of acceptable/unacceptable disturbance events that can potentially occur in the shared environment 105. Therefore, the model 126 can continually mature and improve over time, and enable the disturbance event classification module 124 to accurately classify disturbance events as being acceptable or unacceptable.

In one example, the disturbance event classification module 124 can determine, using the model 126, that a detected disturbance event is unacceptable when an annoyance level for a plurality of users in the shared environment 105 due to the disturbance event exceeds a defined threshold. For example, the model 126 can track which disturbance events are considered annoying or not annoying in view of the behavior of a plurality of users in the shared environment 105. Certain disturbance events, such as loud eating noises, can be considered more annoying than other disturbance events, such as phone calls. The annoyance level can be configured by a systems administrator and can be a dynamic level depending on the type of disturbance event.

In one example, a user can be considered annoyed when the user is unable to perform work or perform work at a certain level of quality due to the disturbance event. For example, the disturbance event can affect a focus or emotional well-being of the user, thereby preventing the user from working on a certain task. Users can be annoyed to excessive noise, distracting sights, foul smells, etc. On the other hand, a user can be considered not annoyed when the user is able to perform work or perform work at a certain level of quality, irrespective of whether a disturbance event occurs.

In one example, the model 126 can be trained to recognize disturbance events for which an annoyance level for a plurality of users in the shared environment 105 exceeds a threshold. For example, the model 126 can obtain user reporting information in which users specify certain types of disturbance events that they consider annoying or a not annoying. Based on the user reporting information, the model 126 can learn to recognize disturbance events that users generally find annoying. In another example, the model 126 can obtain information (e.g., information derived from the sensor data 112) that indicate a frequency of users changing positions in the shared environment 105, a frequency of users giving glares or inquiring looks in the shared environment 105, a frequency of users putting on headphones in the shared environment 105, etc., and this information can be correlated with disturbance events that occur in the shared environment 105. As a result, the model 126 can learn which of these disturbance events are considered annoying by users in the shared environment 105 due to the presence (or absence) of users changing positions, users glaring, users putting on headphones, other types of body language, etc. In another example, the model 126 can obtain information about noise thresholds at which users in the shared environment 105 are annoyed. For example, the model 126 can learn that ambient noise (i.e., a disturbance event) at a first noise level or decibel level in the shared environment 105 is not annoying, but ambient noise at a second noise level or decibel level in the shared environment 105 is annoying, or ambient noise in the shared environment 105 that is above a certain noise threshold is considered annoying for users. Therefore, the model 126 can obtain information over time that enables the model 126 to recognize disturbance events that are considered annoying for users (and therefore unacceptable) versus disturbance events that are considered not annoying for users (and therefore acceptable).

In one example, the disturbance event classification module 124 can determine, using the model 126, an annoyance level for a detected disturbance event. The disturbance event classification module 124 can determine the annoyance level based on historical data on the types of disturbance events that users find annoying or not annoying. The disturbance event classification module 124 can compare the annoyance level for the detected disturbance event to the defined threshold. When the annoyance level is above the defined threshold, the notification module 128 can send the unacceptable event notification 132 to one or more user devices 130.

In one example, the model 126 can account for exceptions made for certain users in the shared environment 105. For example, certain users can have special circumstances, such that events caused by those users that would generally be disturbing for other users in the shared environment can be permitted and do not flag an occurrence of a disturbance event. For example, if a certain employee has a physical impairment that necessitates that the employee use a speakerphone for making phone calls, while those phone calls might generally be considered disruptive to surrounding users and trigger a detection of a disturbance event, that certain employee can be exempted due to the special circumstances and a disturbance event may not be detected or reported when that employee engages in an exempted activity.

In one configuration, the processing device 120 can include a notification module 128 configured to send an unacceptable event notification 132 to one or more users in the shared environment 105 via the user devices 130. For example, when the disturbance event classification module 124 determines using the model 126 that a detected disturbance event is unacceptable, the notification module 128 can send the unacceptable event notification 132 to the one or more user devices 130 in the shared environment 105. The unacceptable event notification 132 can be an audio/visual notification that is displayed on the user device 130. The unacceptable event notification 132 can include a suggestion to cease the disturbance event. For example, the unacceptable event notification can indicate a type of disturbance event that has occurred, an estimated number of users in the shared environment 105 that are bothered or affected by the disturbance event, and a suggestion for ceasing and avoiding the disturbance event in the future.

In one example, the disturbance event detection module 122 can determine one or more users in the shared environment 105 that are in part responsible for the disturbance event based on the sensor data 112 received from the sensors 110. For example, the disturbance event detection module 122 can identify a particular user or a group of users in the shared environment 105 that are responsible for causing the disturbance event. In one example, the sensors 110 can be attached or associated with a particular user in the shared environment 105. Thus, sensor data 112 captured by particular sensors 110 can identify the users associated with those particular sensors 110 as being responsible for causing the disturbance event. In addition, the notification module 128 can send the unacceptable event notification 132 to the users that are in part responsible for the disturbance event when the disturbance event is unacceptable.

In one example, based on the unacceptable event notification 132, users that are causing a disturbance in the shared environment 105 can be notified of their actions. The users that are causing the disturbance can be performing those actions intentionally or unintentionally, and the unacceptable event notification 132 may encourage the user to modify their behavior to make other users more comfortable and increase productivity in the shared environment 105.

In one example, the unacceptable event notification 132 can be sent to the user devices 130 and/or a manager device in the shared environment 105. For example, the manager device can be associated with a supervisor or manager in the shared environment 105. As a result, the supervisor can be notified when certain employees are causing disturbance events in the shared environment 105. Further, the processing device 120 can track a number of disturbance events per employee, and determine whether certain employees show a pattern of causing disturbance events in the shared environment 105. In other words, the disturbance events can be logged in a system and accessible to the supervisor or a system administrator. The supervisor can receive unacceptable event notifications 132 and make business or personnel decisions in view of the unacceptable event notifications 132.

In one example, by automatically sending the unacceptable event notification 132 to the user in part responsible for the disturbance events, other users in the shared environment 105 can avoid uncomfortable conversations with user(s) that are responsible for disturbance events in the shared environment 105. When users that are causing disturbance events are notified of their actions and take steps to minimize the occurrence of disturbance events in the future, the overall productivity and morale can be increase for the shared environment 105.

In one configuration, the disturbance event detection module 122 can determine one or more users in the shared environment 105 that are not responsible for the disturbance event based on the sensor data 112 received from the sensors 110. For example, the disturbance event detection module 122 can identify a particular user or a group of users in the shared environment 105 that are not responsible for causing the disturbance event. In one example, when the sensors 110 are attached or associated with a particular user in the shared environment 105, sensor data 112 captured by particular sensors 110 can infer that the users associated with those particular sensors 110 are not responsible for causing the disturbance event. In other words, the disturbance event can be detected based on sensor data 112 received from particular sensors 110, and for those sensors 110 that send sensor data 112 that does not trigger the detection of the disturbance event, the users associated with those sensors 110 can be presumed to be not responsible for causing the disturbance event. In addition, the notification module 128 can determine to not send the unacceptable event notification 132 to the users that are not responsible for the disturbance event when the disturbance event is unacceptable.

In one configuration, the disturbance event detection module 122 can use voice recognition or speech recognition to identify a particular user or a group of users in the shared environment 105 that are not responsible for causing the disturbance event. For example, the disturbance event detection module 122 can include voice samples for users in the shared environment 105. The disturbance event detection module 122 can compare sensor data 112 (e.g., audio data) to the voice samples and identify a particular user that is associated with the sensor data 112, when the sensor data 112 indicates that a disturbance event has occurred in the shared environment 105.

In one example, the disturbance event classification module 124 can determine, using the model 126, that a detected disturbance event is acceptable. The notification module 128 can determine to not send a notification to one or more users that are in part responsible for the disturbance event that is acceptable. In other words, when disturbance events occur that are acceptable, the users that are in part responsible for causing the acceptable disturbance events do not receive a notification.

In one example, the processing device 120 may receive the sensor data 112 from the sensors 110, and the processing device 120 can delete the sensor data 112 after a defined period of time. Thus, the sensor data 112 can be stored on the processing device 120 for a limited duration of time. In one example, the processing data 120 can receive the sensor data 112 and process the sensor data 112 to determine whether a disturbance event has occurred. When the sensor data 112 does not indicate an occurrence of a disturbance event, that sensor data 112 can be deleted from the processing device 120.

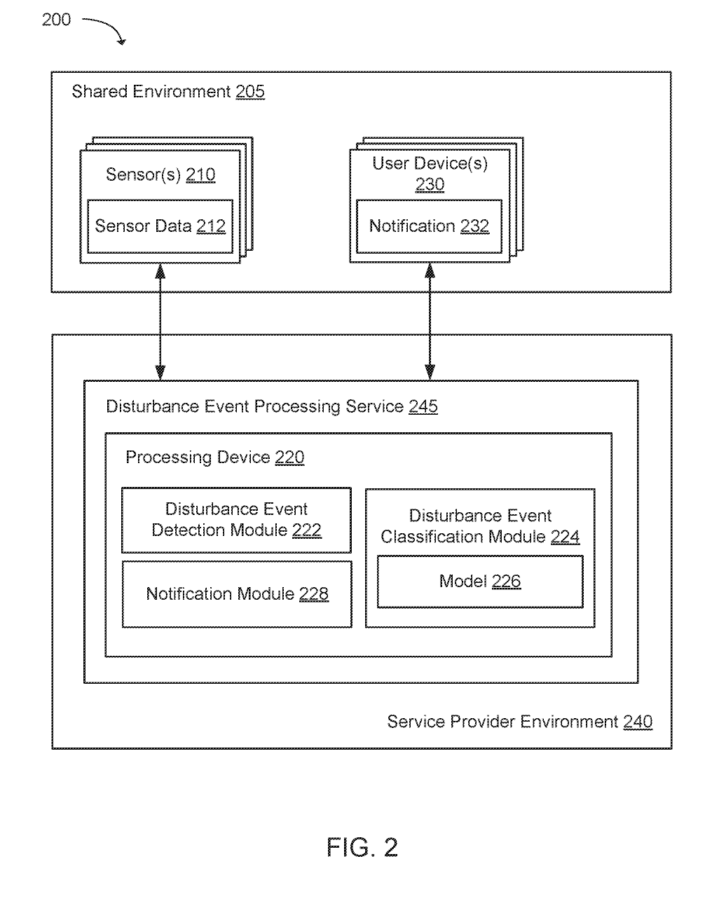

FIG. 2 illustrates an exemplary system 200 for detecting disturbance events in a shared environment 205. The system 200 can monitor disturbance events that occur in the shared environment 205 on a real-time basis. For example, the system 200 can be installed in the shared environment 205, and the system 200 can monitor and notify about disturbance events that are detected in the shared environment 205. The shared environment 205 can include a plurality of sensor(s) 210 and a plurality of user device(s) 230. The sensors 210 can send sensor data 212 to a disturbance event processing service 245 that operates in a service provider environment 240 (or cloud environment). The disturbance event processing service 245 can operate a processing device 220 that includes a disturbance event detection module 222, a disturbance event classification module 224 and a notification module 228. The disturbance event detection module 222 can detect a disturbance event in the shared environment 205 based on the sensor data 212. The disturbance event classification module 224 can determine, using a model 226, whether the disturbance event is acceptable or unacceptable. The notification module 228 can send a notification 232 to the user device(s) 230 (which can be associated with one or more users) when the disturbance event is unacceptable. In this configuration, the processing of the sensor data 212 can be performed off-premise (e.g., in the cloud environment), as opposed to being performed on premise, as shown in FIG. 1

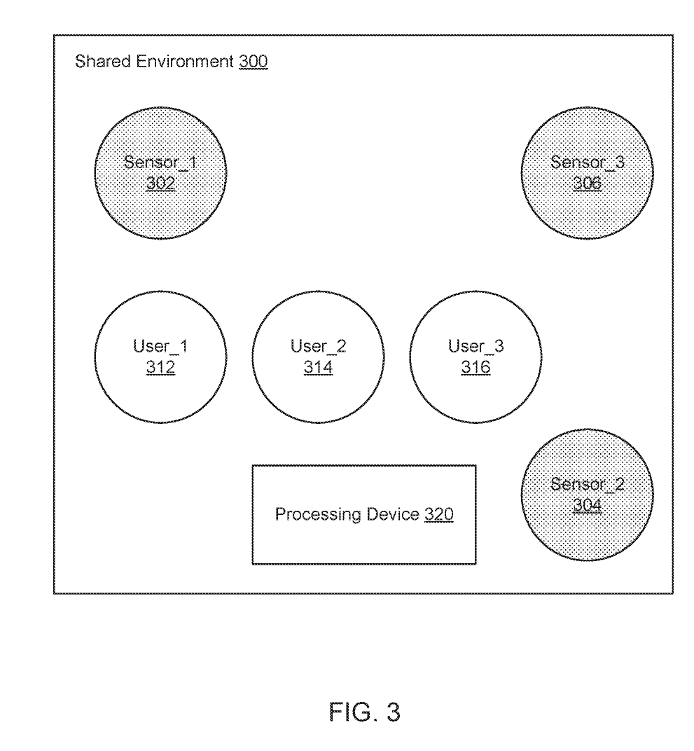

FIG. 3 illustrates an example of a layout of a shared environment 300. The shared environment 300 can include a plurality of sensors, such as a first sensor (sensor_1) 302, a second sensor (sensor_2) 304, and a third sensor (sensor_3) 306. The sensors can include, but are not limited to, sound detectors, video cameras, temperature sensors, photo sensors, motion detectors, vibration sensors, etc. A plurality of users, such as a first user (user_1) 312, a second user (user_2) 314, and a third user (user_3) 316, can be spread out across the shared environment 300. For example, when the shared environment 300 is an open-space office setting, the users 312, 314, 316 can sit in various areas of the shared environment 300. The sensors 302, 304, 306 can be strategically installed in selected areas of the shared environment 300 to detect sounds, motions, smells, etc. caused by the users 312, 314, 316 in the shared environment 300. In addition, in this configuration, a processing device 320 can be installed within the shared environment 300, and the processing device 320 may process sensor data received from the sensors 302, 304, 306 installed in the shared environment 300.

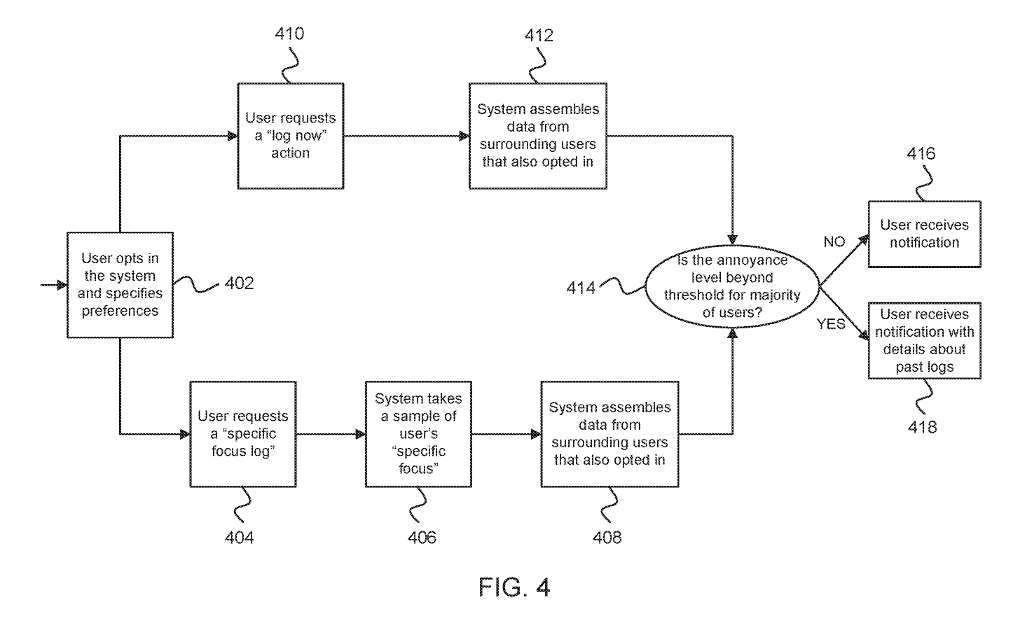

FIG. 4 illustrates an exemplary technique for providing notifications to users regarding disturbance events. The technique can include a user in a shared environment opting into a system that detects disturbance events and specifying user preferences (block 402). In a first option, the user can request a specific focus log (block 404), and the system can take a sample of the user's specific focus (block 406), and the system can assemble data from surrounding users that also opted into the system (block 408). In a second option, the user can request a log now action (block 410), and the system can assemble data from surrounding users that also opted into the system (block 412). In both the first option and the second option, whether an annoyance level is beyond a threshold for a majority of users can be determined (block 414). When the annoyance level is not beyond the threshold, the user can receive a notification (block 416). Alternatively, when the annoyance level is beyond the threshold, the user can receive a notification with details about past logs (block 418).

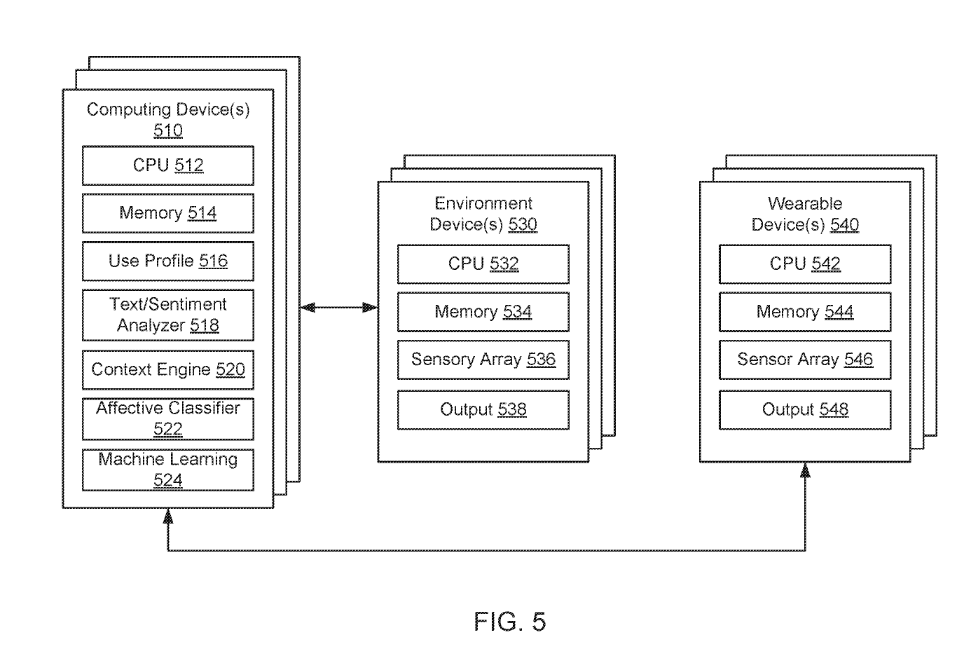

FIG. 5 illustrates examples of environment device(s) 530 and wearable device(s) 540 for capturing sensor data and computing device(s) 510 for processing the sensor data. The computing devices 510 can include processor(s) 512, memory 514, user profile(s) 516, a text/sentiment analyzer 518, a context engine 520, an affective classifier 522 and a machine learning model 524. For example, the user profile(s) 516 can include specific actions or sounds made by a user that are considered acceptable or not acceptable. The text/sentiment analyzer 518 (or emotion AI) can provide an understanding of social sentiment from sensor data, or can provide contextual mining that identifies and extracts subjective information from the sensor data. The context engine 520 can provide context to captured sensor data, and can be used when determining whether certain events are considered disruptive and acceptable/not acceptable. The affective classifier 522 (or emotion AI) can be used to recognize, interpret and process human affects based on sensor data. The machine learning model 524 can be used to determine whether certain events are considered disruptive and acceptable/not acceptable. Furthermore, the environment devices 530 and the wearable devices 540 can each include processor(s) 532, 542, memory 534, 544, a sensor array 536, 546 for capturing sensor data and/or an output 538, 548 for providing the sensor data to the computing device 510.

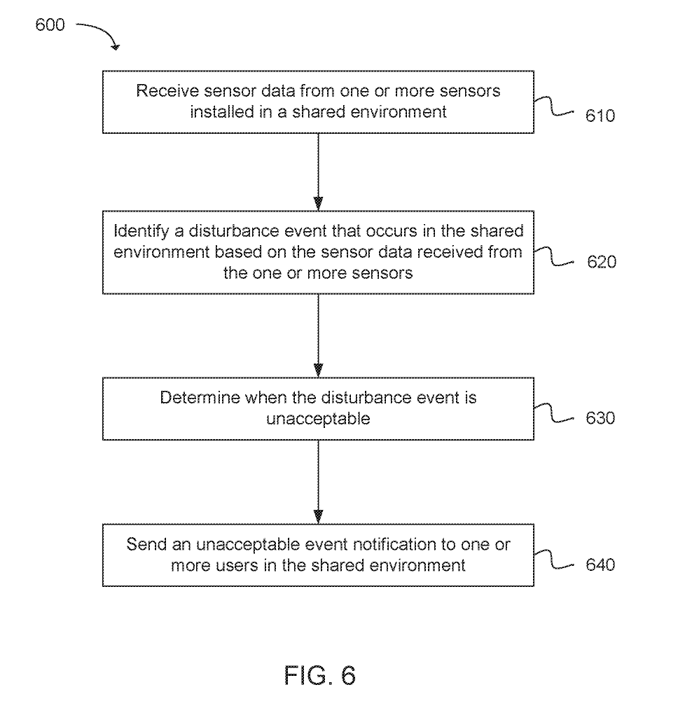

Another example provides a method 600 for detecting a disturbance event in a shared environment, as shown in the flow chart in FIG. 6. The method can be executed as instructions on a machine, where the instructions are included on at least one computer readable medium or one non-transitory machine readable storage medium. The method can include the operation of receiving sensor data from one or more sensors installed in the shared environment, as in block 610. The method can include the operation of identifying the disturbance event that occurs in the shared environment based on the sensor data received from the one or more sensors, as in block 620. The method can include the operation of determining when the disturbance event is unacceptable, as in block 630. The method can include the operation of sending an unacceptable event notification to one or more users in the shared environment, as in block 640.

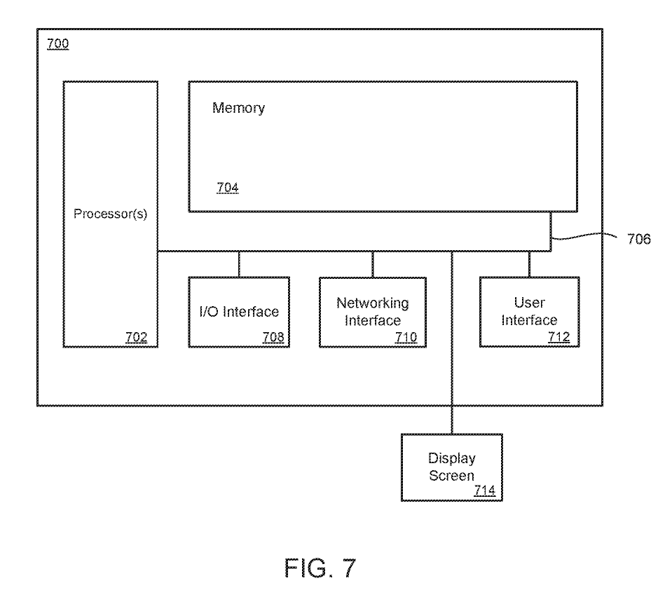

FIG. 7 illustrates a general computing system or device 700 that can be employed in the present technology. The computing system 700 can include a processor 702 in communication with a memory 704. The memory 704 can include any device, combination of devices, circuitry, and the like that is capable of storing, accessing, organizing, and/or retrieving data. Non-limiting examples include SANs (Storage Area Network), cloud storage networks, volatile or non-volatile RAM, phase change memory, optical media, hard-drive type media, and the like, including combinations thereof.

The computing system or device 700 additionally includes a local communication interface 706 for connectivity between the various components of the system. For example, the local communication interface 706 can be a local data bus and/or any related address or control busses as may be desired.

The computing system or device 700 can also include an I/O (input/output) interface 708 for controlling the I/O functions of the system, as well as for I/O connectivity to devices outside of the computing system 700. A network interface 710 can also be included for network connectivity. The network interface 710 can control network communications both within the system and outside of the system. The network interface can include a wired interface, a wireless interface, a Bluetooth interface, optical interface, and the like, including appropriate combinations thereof. Furthermore, the computing system 700 can additionally include a user interface 712, a display device 714, as well as various other components that would be beneficial for such a system.

The processor 702 can be a single or multiple processors, and the memory 704 can be a single or multiple memories. The local communication interface 706 can be used as a pathway to facilitate communication between any of a single processor, multiple processors, a single memory, multiple memories, the various interfaces, and the like, in any useful combination.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations. Exemplary systems or devices can include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

### EXAMPLES

The following examples pertain to specific technology embodiments and point out specific features, elements, or steps that can be used or otherwise combined in achieving such embodiments.

In one example, there is provided a controller. The controller can include logic to receive sensor data from one or more sensors installed in a shared environment. The controller can include logic to identify a disturbance event that occurs in the shared environment based on the sensor data received from the one or more sensors. The controller can include logic to determine when the disturbance event is unacceptable. The controller can include logic to send an unacceptable event notification to one or more users in the shared environment.

In one example of the controller, the controller can include logic to send the unacceptable event notification to one or more users that are in part responsible for the disturbance event when the disturbance event is unacceptable.

In one example of the controller, the unacceptable event notification is an audio/visual notification that includes a suggestion to cease the disturbance event.

In one example of the controller, the disturbance event that occurs in the shared environment is unacceptable when an annoyance level for a plurality of users in the shared environment due to the disturbance event exceeds a defined threshold.

In one example of the controller, the controller can include logic to determine that the disturbance event that occurs in the shared environment is unacceptable when one or more of a noise level associated with the disturbance event or a duration of the disturbance event exceeds a defined threshold.

In one example of the controller, the controller can include logic to: determine one or more users in the shared environment that are not responsible for the disturbance event based on the sensor data received from the one or more sensors; and determine to not send the unacceptable event notification to the one or more users in the shared environment that are not responsible for the disturbance event.

In one example of the controller, the controller can include logic to: generate a machine learning model; determine when the disturbance event that occurs in the shared environment is unacceptable using the machine learning model; and determine, using the machine learning model, when the disturbance event that occurs in the shared environment is acceptable, wherein unacceptable event notifications are not sent to users that are in part responsible for disturbance events that are acceptable.

In one example of the controller, the controller can include logic to train the machine learning model to distinguish between disturbance events which are unacceptable versus disturbance events which are acceptable.

In one example of the controller, the controller can include logic to train the machine learning model to recognize an annoyance level for a certain type of disturbance event based on training data that defines types of disturbance events that users consider annoying or not annoying.

In one example of the controller, the controller can include logic to delete the sensor data after a defined period of time.

In one example of the controller, the sensor data received from the one or more sensors includes one or more of: audio/video data, temperature data, photo sensor data, motion data or vibration data.

In one example, there is provided a system to monitor disturbance in a shared environment. The system can include a plurality of sensors operable to capture sensor data in the shared environment. The system can include one or more processors. The one or more processors can receive the sensor data from one or more sensors in the plurality of sensors. The one or more processors can identify a disturbance event that occurs in the shared environment based on the sensor data received from the one or more sensors. The one or more processors can determine, using a machine learning model, when the disturbance event that occurs in the shared environment is unacceptable. The one or more processors can send an unacceptable event notification to one or more users in the shared environment.

In one example of the system, the one or more processors are configured to: determine one or more users in the shared environment that are in part responsible for the disturbance event based on the sensor data received from the one or more sensors; and send the unacceptable event notification to the one or more users that are in part responsible for the disturbance event when the disturbance event is unacceptable.

In one example of the system, the unacceptable event notification is an audio/visual notification that includes a suggestion to cease the disturbance event.

In one example of the system, the disturbance event that occurs in the shared environment is unacceptable when an annoyance level for a plurality of users in the shared environment due to the disturbance event exceeds a defined threshold.

In one example of the system, the one or more processors are configured to determine that the disturbance event that occurs in the shared environment is unacceptable when one or more of a noise level associated with the disturbance event or a duration of the disturbance event exceeds a defined threshold.

In one example of the system, the one or more processors are configured to: determine one or more users in the shared environment that are not responsible for the disturbance event based on the data received from the one or more sensors; and determine to not send the unacceptable event notification to the one or more users in the shared environment that are not responsible for the disturbance event.

In one example of the system, the one or more processors are configured to determine, using the machine learning model, when the disturbance event that occurs in the shared environment is acceptable, wherein unacceptable event notifications are not sent to users that are in part responsible for disturbance events that are acceptable.

In one example of the system, the one or more processors are configured to: generate the machine learning model; train the machine learning model to distinguish between disturbance events which are unacceptable versus disturbance events which are acceptable; and train the machine learning model to recognize an annoyance level for a certain type of disturbance event based on training data that defines types of disturbance events that users consider annoying or not annoying.

In one example of the system, the one or more processors are configured to delete the sensor data received from the plurality of sensors after a defined period of time.

In one example of the system, the sensor data received from the plurality of sensors includes one or more of: audio/video data, temperature data, photo sensor data, motion data or vibration data.

In one example of the system, the plurality of sensors include one or more of: sound detectors, video cameras, temperature sensors, photo sensors, motion detectors or vibration sensors.

In one example of the system, the system is operable to monitor disturbance events that occur in the shared environment on a real-time basis.

In one example of the system, the system is installed in a shared work environment.

In one example, there is provided a method of making a disturbance monitoring device. The method can include providing a plurality of sensors operable to capture sensor data in a shared environment. The method can include configuring one or more processors that are in communication with the plurality of sensors to perform the following: receiving the sensor data from one or more sensors in the plurality of sensors; identifying a disturbance event that occurs in the shared environment based on the sensor data received from the one or more sensors; determining, using a machine learning model, when the disturbance event that occurs in the shared environment is unacceptable; and sending an unacceptable event notification to one or more users in the shared environment.

In one example of the method of making the disturbance monitoring device, the method can include configuring the one or more processors in the disturbance monitoring device to perform the following: determining one or more users in the shared environment that are in part responsible for the disturbance event based on the sensor data received from the one or more sensors; and sending the unacceptable event notification to the one or more users that are in part responsible for the disturbance event when the disturbance event is unacceptable.

In one example of the method of making the disturbance monitoring device, the unacceptable event notification is an audio/visual notification that includes a suggestion to cease the disturbance event.

In one example of the method of making the disturbance monitoring device, the disturbance event that occurs in the shared environment is unacceptable when an annoyance level for a plurality of users in the shared environment due to the disturbance event exceeds a defined threshold.

In one example of the method of making the disturbance monitoring device, the method can include configuring the one or more processors in the disturbance monitoring device to perform the following: determining that the disturbance event that occurs in the shared environment is unacceptable when one or more of a noise level associated with the disturbance event or a duration of the disturbance event exceeds a defined threshold.

In one example of the method of making the disturbance monitoring device, the method can include configuring the one or more processors in the disturbance monitoring device to perform the following: determining one or more users in the shared environment that are not responsible for the disturbance event based on the sensor data received from the one or more sensors; and determining to not send the unacceptable event notification to the one or more users in the shared environment that are not responsible for the disturbance event.

In one example of the method of making the disturbance monitoring device, the method can include configuring the one or more processors in the disturbance monitoring device to perform the following: determining, using the machine learning model, when the disturbance event that occurs in the shared environment is acceptable, wherein unacceptable event notifications are not sent to users that are in part responsible for disturbance events that are acceptable.

In one example of the method of making the disturbance monitoring device, the method can include configuring the one or more processors in the disturbance monitoring device to perform the following: generating the machine learning model; training the machine learning model to distinguish between disturbance events which are unacceptable versus disturbance events which are acceptable; and training the machine learning model to recognize an annoyance level for a certain type of disturbance event based on training data that defines types of disturbance events that users consider annoying or not annoying.

In one example of the method of making the disturbance monitoring device, the method can include configuring the one or more processors in the disturbance monitoring device to perform the following: deleting the sensor data received from the plurality of sensors after a defined period of time.

In one example, there is provided at least one non-transitory machine readable storage medium having instructions embodied thereon. The instructions when executed by a server performs the following: receiving sensor data from one or more sensors installed in a shared environment; identifying a disturbance event that occurs in the shared environment based on the sensor data received from the one or more sensors; determining, using a machine learning model, when the disturbance event that occurs in the shared environment is unacceptable; and sending an unacceptable event notification to one or more users in the shared environment.

In one example of the at least one non-transitory machine readable storage medium, the non-transitory machine readable storage medium further comprises instructions when executed perform the following: determining one or more users in the shared environment that are in part responsible for the disturbance event based on the sensor data received from the one or more sensors; and sending the unacceptable event notification to the one or more users that are in part responsible for the disturbance event when the disturbance event is unacceptable.

In one example of the at least one non-transitory machine readable storage medium, the unacceptable event notification is an audio/visual notification that includes a suggestion to cease the disturbance event.

In one example of the at least one non-transitory machine readable storage medium, the disturbance event that occurs in the shared environment is unacceptable when an annoyance level for a plurality of users in the shared environment due to the disturbance event exceeds a defined threshold.

In one example of the at least one non-transitory machine readable storage medium, the non-transitory machine readable storage medium further comprises instructions when executed perform the following: determining that the disturbance event that occurs in the shared environment is unacceptable when one or more of a noise level associated with the disturbance event or a duration of the disturbance event exceeds a defined threshold.

In one example of the at least one non-transitory machine readable storage medium, the non-transitory machine readable storage medium further comprises instructions when executed perform the following: determining one or more users in the shared environment that are not responsible for the disturbance event based on the sensor data received from the one or more sensors; and determining to not send the unacceptable event notification to the one or more users in the shared environment that are not responsible for the disturbance event.

In one example of the at least one non-transitory machine readable storage medium, the non-transitory machine readable storage medium further comprises instructions when executed perform the following: determining, using the machine learning model, when the disturbance event that occurs in the shared environment is acceptable, wherein unacceptable event notifications are not sent to users that are in part responsible for disturbance events that are acceptable.

In one example of the at least one non-transitory machine readable storage medium, the non-transitory machine readable storage medium further comprises instructions when executed perform the following: generating the machine learning model; training the machine learning model to distinguish between disturbance events which are unacceptable versus disturbance events which are acceptable; and training the machine learning model to recognize an annoyance level for a certain type of disturbance event based on training data that defines types of disturbance events that users consider annoying or not annoying.

In one example of the at least one non-transitory machine readable storage medium, the non-transitory machine readable storage medium further comprises instructions when executed perform the following: deleting the sensor data received from the plurality of sensors after a defined period of time.

In one example, there is provided a method of detecting disturbance events. The method can include receiving sensor data from one or more sensors installed in a shared environment. The method can include identifying a disturbance event that occurs in the shared environment based on the sensor data received from the one or more sensors. The method can include determining when the disturbance event is unacceptable. The method can include sending an unacceptable event notification to one or more users in the shared environment

In one example of the method of detecting disturbance events, the method can include sending the unacceptable event notification to one or more users that are in part responsible for the disturbance event when the disturbance event is unacceptable.

In one example of the method of detecting disturbance events, the unacceptable event notification is an audio/visual notification that includes a suggestion to cease the disturbance event.

In one example of the method of detecting disturbance events, the disturbance event that occurs in the shared environment is unacceptable when an annoyance level for a plurality of users in the shared environment due to the disturbance event exceeds a defined threshold.

In one example of the method of detecting disturbance events, the method can include determining that the disturbance event that occurs in the shared environment is unacceptable when one or more of a noise level associated with the disturbance event or a duration of the disturbance event exceeds a defined threshold.

In one example of the method of detecting disturbance events, the method can include: determining one or more users in the shared environment that are not responsible for the disturbance event based on the sensor data received from the one or more sensors; and determining to not send the unacceptable event notification to the one or more users in the shared environment that are not responsible for the disturbance event.

In one example of the method of detecting disturbance events, the method can include: generating a machine learning model; determining when the disturbance event that occurs in the shared environment is unacceptable using the machine learning model; and determining, using the machine learning model, when the disturbance event that occurs in the shared environment is acceptable, wherein unacceptable event notifications are not sent to users that are in part responsible for disturbance events that are acceptable.

In one example of the method of detecting disturbance events, the method can include: training the machine learning model to distinguish between disturbance events which are unacceptable versus disturbance events which are acceptable; and training the machine learning model to recognize an annoyance level for a certain type of disturbance event based on training data that defines types of disturbance events that users consider annoying or not annoying.

In one example of the method of detecting disturbance events, the sensor data received from the one or more sensors includes one or more of: audio/video data, temperature data, photo sensor data, motion data or vibration data.

While the forgoing examples are illustrative of the principles of technology embodiments in one or more particular applications, it will be apparent to those of ordinary skill in the art that numerous modifications in form, usage and details of implementation can be made without the exercise of inventive faculty, and without departing from the principles and concepts of the disclosure.

What is claimed is:

1. A controller, comprising logic to:
receive sensor data from one or more sensors installed in a shared environment;
identify a disturbance event that occurs in the shared environment based on the sensor data received from the one or more sensors;
determine when the disturbance event is unacceptable; and
send an unacceptable event notification to one or more users in the shared environment.

2. The controller of claim 1, further comprising logic to send the unacceptable event notification to one or more users that are in part responsible for the disturbance event when the disturbance event is unacceptable.

3. The controller of claim 1, wherein the unacceptable event notification is an audio/visual notification that includes a suggestion to cease the disturbance event.

4. The controller of claim 1, wherein the disturbance event that occurs in the shared environment is unacceptable when an annoyance level for a plurality of users in the shared environment due to the disturbance event exceeds a defined threshold.

5. The controller of claim 1, further comprising logic to determine that the disturbance event that occurs in the shared environment is unacceptable when one or more of a noise level associated with the disturbance event or a duration of the disturbance event exceeds a defined threshold.

6. The controller of claim 1, further comprising logic to:
determine one or more users in the shared environment that are not responsible for the disturbance event based on the sensor data received from the one or more sensors; and
determine to not send the unacceptable event notification to the one or more users in the shared environment that are not responsible for the disturbance event.

7. The controller of claim 1, further comprising logic to:
generate a machine learning model;
determine when the disturbance event that occurs in the shared environment is unacceptable using the machine learning model; and
determine, using the machine learning model, when the disturbance event that occurs in the shared environment is acceptable, wherein unacceptable event notifications are not sent to users that are in part responsible for disturbance events that are acceptable.

8. The controller of claim 7, further comprising logic to train the machine learning model to distinguish between disturbance events which are unacceptable versus disturbance events which are acceptable.

9. The controller of claim 8, further comprising logic to train the machine learning model to recognize an annoyance level for a certain type of disturbance event based on training data that defines types of disturbance events that users consider annoying or not annoying.

10. The controller of claim 1, further comprising logic to delete the sensor data after a defined period of time.

11. The controller of claim 1, wherein the sensor data received from the one or more sensors includes one or more of: audio/video data, temperature data, photo sensor data, motion data or vibration data.

12. A system to monitor disturbance in a shared environment, the system comprising:
a plurality of sensors operable to capture sensor data in the shared environment; and
one or more processors configured to:
receive the sensor data from one or more sensors in the plurality of sensors;
identify a disturbance event that occurs in the shared environment based on the sensor data received from the one or more sensors;
determine, using a machine learning model, when the disturbance event that occurs in the shared environment is unacceptable; and
send an unacceptable event notification to one or more users in the shared environment.

13. The system of claim 12, wherein the one or more processors are configured to:
determine one or more users in the shared environment that are in part responsible for the disturbance event based on the sensor data received from the one or more sensors; and
send the unacceptable event notification to the one or more users that are in part responsible for the disturbance event when the disturbance event is unacceptable.

14. The system of claim 12, wherein the unacceptable event notification is an audio/visual notification that includes a suggestion to cease the disturbance event.

15. The system of claim 12, wherein the disturbance event that occurs in the shared environment is unacceptable when an annoyance level for a plurality of users in the shared environment due to the disturbance event exceeds a defined threshold.

16. The system of claim 12, wherein the one or more processors are configured to determine that the disturbance event that occurs in the shared environment is unacceptable when one or more of a noise level associated with the disturbance event or a duration of the disturbance event exceeds a defined threshold.

17. The system of claim 12, wherein the one or more processors are configured to:
determine one or more users in the shared environment that are not responsible for the disturbance event based on the data received from the one or more sensors; and
determine to not send the unacceptable event notification to the one or more users in the shared environment that are not responsible for the disturbance event.

18. The system of claim 12, wherein the one or more processors are further configured to determine, using the machine learning model, when the disturbance event that occurs in the shared environment is acceptable, wherein unacceptable event notifications are not sent to users that are in part responsible for disturbance events that are acceptable.

19. The system of claim 12, wherein the one or more processors are further configured to:
generate the machine learning model;
train the machine learning model to distinguish between disturbance events which are unacceptable versus disturbance events which are acceptable; and
train the machine learning model to recognize an annoyance level for a certain type of disturbance event based on training data that defines types of disturbance events that users consider annoying or not annoying.

20. The system of claim 12, wherein the one or more processors are further configured to delete the sensor data received from the plurality of sensors after a defined period of time.

21. The system of claim 12, wherein the sensor data received from the plurality of sensors includes one or more of: audio/video data, temperature data, photo sensor data, motion data or vibration data.

22. The system of claim 12, wherein the plurality of sensors include one or more of: sound detectors, video cameras, temperature sensors, photo sensors, motion detectors or vibration sensors.

23. The system of claim 12, wherein the system is operable to monitor disturbance events that occur in the shared environment on a real-time basis.

24. The system of claim 12, wherein the system is installed in a shared work environment.
